(19) United States
(12) Patent Application Publication
(10) Pub. No.: US 2020/0091763 A1
(43) Pub. Date: Mar. 19, 2020

(54) BATTERY BACKUP DEVICES AND SYSTEMS FOR GARAGE DOOR OPENERS

(71) Applicant: TECHTRONIC CORDLESS GP, Anderson, SC (US)

(72) Inventor: Scott P. Kippes, Piedmont, SC (US)

(21) Appl. No.: 16/572,758

(22) Filed: Sep. 17, 2019

Related U.S. Application Data
(60) Provisional application No. 62/733,423, filed on Sep. 19, 2018.

(51) Int. Cl. H02J 9/06; G08C 17/02; G06F 1/28; G06F 1/26; G07C 9/00

(52) U.S. Cl. CPC H02J 9/062; G08C 17/02; G07C 2009/00928; G06F 1/263; G07C 9/00896; G06F 1/28

(57) ABSTRACT

A battery backup device for a garage door opener. The battery backup device includes a housing and one or more accessory ports for receiving one or more accessories. The battery backup device is configured to use received AC power to provide power to the one or more accessories. The battery backup device is also configured to pass AC power through to an AC power outlet. The AC power outlet is configured to receive a standard AC power plug from a garage door opener. When AC power is available to the battery backup device, AC power may be passed through the battery backup device to the AC power outlet. When AC power is not available to the battery backup device, the battery backup device is configured to invert DC power from a battery pack to produce AC power. The AC power may then be provided to the AC power outlet.

### RELATED APPLICATIONS

This application claims the benefit of U.S. Provisional Patent Application No. 62/733,423, filed Sep. 19, 2018, the entire content of which is hereby incorporated by reference.

### FIELD

Embodiments described herein relate to battery backup devices and systems for a garage door opener.

### BACKGROUND

Garage door openers are conventionally powered by alternating current (“AC”) mains power.

### SUMMARY

Embodiments described herein provide a battery backup device for a garage door opener. In some embodiments, the battery backup device includes a housing and one or more accessory ports for receiving one or more accessories (e.g., a battery pack, a battery pack charger, a speaker, a security camera, etc.). The battery backup device is configured to receive alternating current (“AC”) power from, for example, AC mains power. The battery backup device is configured to use the received AC power to provide power to the one or more accessories (e.g., received AC power is rectified to DC power to charge a battery pack). Additionally, the battery backup device is configured to pass AC power through to an AC power outlet. The AC power outlet is configured to receive a standard AC power plug from, for example, a garage door opener. When AC power is available to the battery backup device, AC power may be passed through the battery backup device to the AC power outlet for powering the garage door opener. When AC power is not available to the battery backup device, the battery backup device is configured to invert DC power from a battery pack (e.g., a battery pack connected to one of the accessory ports) to produce AC power. The AC power may then be provided to the AC power outlet for powering the garage door opener.

Embodiments described herein provide a battery backup device for a garage door opener. The battery backup device includes a housing, an accessory port, a power input module, a power output module, and a controller. The accessory port is configured to receive a removable and rechargeable battery pack. The power input module is configured to receive alternating current (“AC”) power. The power output module is configured to output AC power to an AC power outlet. The controller is configured to provide power to the accessory port, receive power from the accessory port, and control a switch between a first mode of operation and a second mode of operation. The first mode of operation includes providing the received AC power to the power output module. The second mode of operation includes providing power from the removable and rechargeable battery pack to the power output module. When the power input module is receiving AC power, the switch is controlled to the first mode of operation. When the power input module is not receiving AC power, the switch is controlled to the second mode of operation.

Embodiments described herein provide a battery backup system for a garage door opener. The system includes a removable and rechargeable battery pack and a battery backup device. The battery backup device includes a housing, an accessory port, a power input module, a power output module, and a controller. The accessory port is configured to receive an accessory. The power input module is configured to receive alternating current (“AC”) power. The power output module is configured to output AC power to an AC power outlet. The controller is configured provide power to the accessory port, receive power from the removable and rechargeable battery pack, and control a switch between a first mode of operation and a second mode of operation. The first mode of operation includes providing the received AC power to the power output module. The second mode of operation includes providing power from the removable and rechargeable battery pack to the power output module. When the power input module is receiving AC power, the switch is controlled to the first mode of operation. When the power input module is not receiving AC power, the switch is controlled to the second mode of operation.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers” and “computing devices” described in the specification may include one or more processing units, one or more computer-readable medium modules, one or more input/output interfaces, and various connections (e.g., a system bus) connecting the components.

Other aspects of the embodiments will become apparent by consideration of the detailed description and accompanying drawings.

### BRIEF DESCRIPTION OF THE DRAWINGS

FIG. 1 illustrates a battery backup device and system for a garage door opener, according to embodiments described herein.

FIG. 2 is an electrical schematic diagram illustrating the connections between the battery backup device, system, and garage door opener of FIG. 1, according to embodiments described herein.

FIG. 3 illustrates a controller for the battery backup device of FIG. 1, according to embodiments described herein.

FIG. 4 illustrates the battery backup device, system, and garage door opener of FIG. 1, according to embodiments described herein.

FIG. 5 illustrates the battery backup device and system of FIG. 1, according to embodiments described herein.

### DETAILED DESCRIPTION

Embodiments described herein provide a battery backup device and system for a garage door opener. The battery backup device includes a housing and one or more accessory ports for receiving one or more accessories (e.g., a battery pack, a battery pack charger, a speaker, a security camera, etc.). The battery backup device is configured to receive alternating current (“AC”) power (e.g., AC mains power). A controller within the battery backup device is configured to selectively control a switch to provide power to an AC power outlet. The controller is also configured to rectify the received AC power to produce DC power for powering the one or more accessories connected to the one or more accessory ports. When the battery backup device is receiving AC power, the controller is configured to control the switch to pass AC power through to the AC power outlet. When the battery backup device is not receiving AC power, the controller is configured to invert DC power drawn from a battery pack (e.g., a battery pack connected to an accessory port) to produce AC power. The produced AC power may be provided to the AC power outlet. The AC power outlet is configured to receive a standard AC power plug from, for example, a garage door opener. As a result, the battery backup device is operable to provide AC power to the AC power outlet regardless of whether AC power is available to the battery backup device. In this way, the garage door opener and/or various accessories connected thereto may continue to function despite a power outage or loss of AC power.

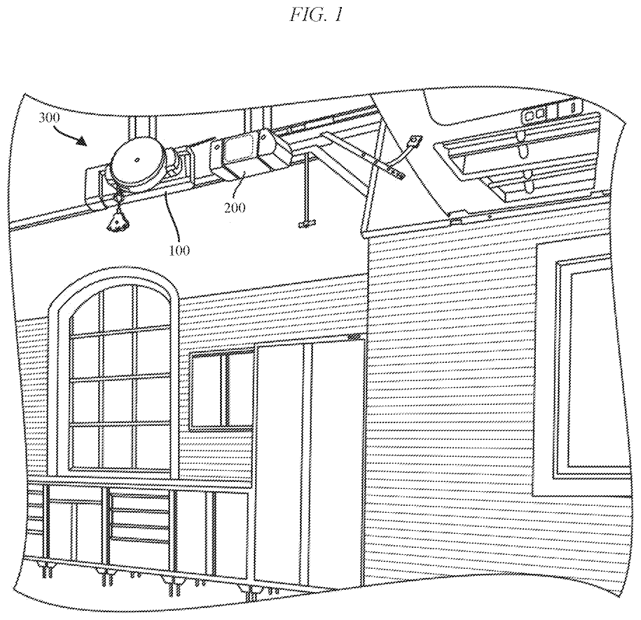

FIG. 1 illustrates a battery backup device 100 for a garage door opener 200. The battery backup device 100 and the garage door opener 200 may each be suspended from a surface (e.g., a ceiling) of a structure (e.g., a building, a garage, etc.). In some embodiments, one or more accessories may be coupled or connected (e.g., mechanically coupled, electrically connected, etc.) to the battery backup device 100 to form a battery backup system 300. The garage door opener 200 may be mounted on a drive mechanism for raising and lowering a garage door.

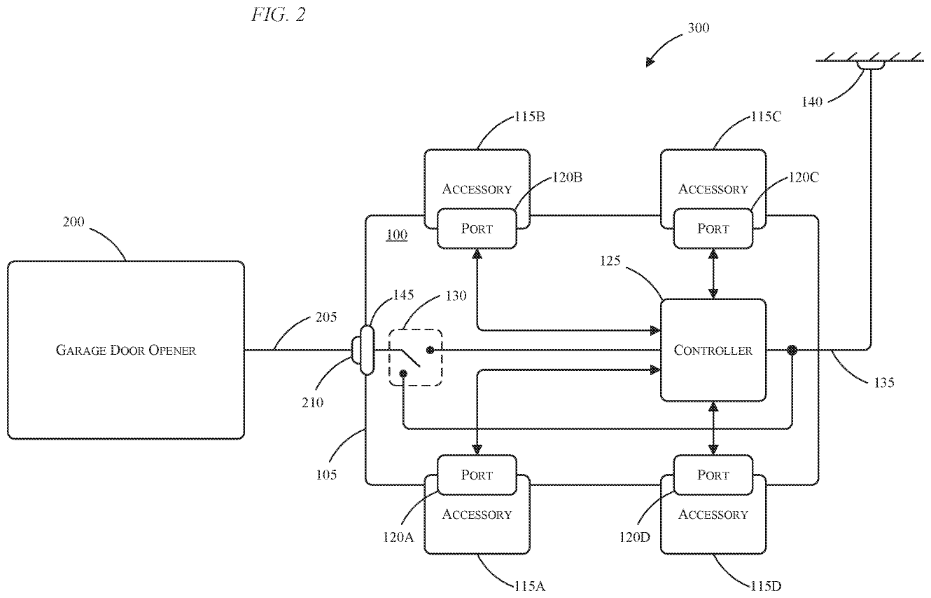

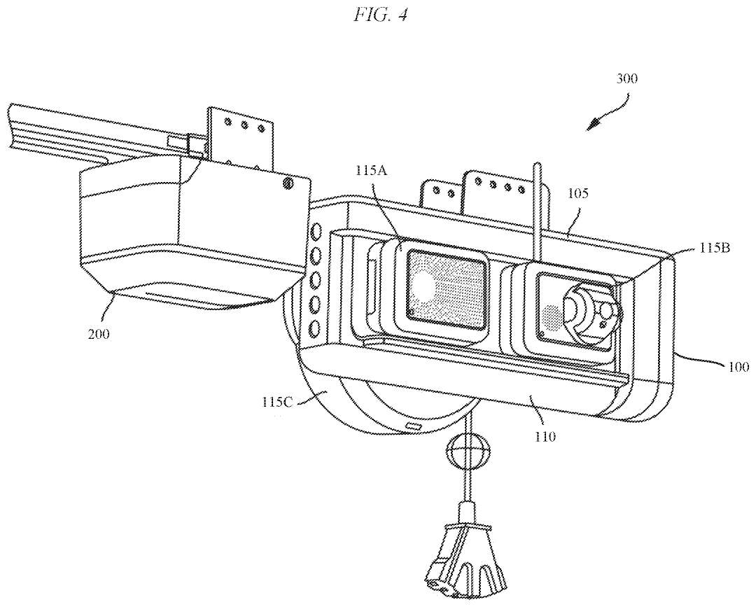

FIG. 2 illustrates the connection between the battery backup device 100, the garage door opener 200, and the system 300. The illustrated battery backup device 100 includes a housing 105, a light 110 (see, e.g., FIG. 4), one or more accessory ports 120 (e.g., sockets, interfaces, USB ports, etc.) for connecting to one or more accessories, and a controller 125. The system 300 includes the battery backup device 100, a first accessory 115A, a second accessory 115B, a third accessory 115C, and a fourth accessory 115D. Each of the accessories 115A-115D may be coupled or connected to the battery backup device 100 via an accessory port 120A-120D. For example, the first accessory 115A may be coupled to a first accessory port 120A. The second accessory 115B may be coupled to a second accessory port 120B. The third accessory 115C may be coupled to a third accessory port 120C. The fourth accessory 115D may be coupled to a fourth accessory port 120D. In some embodiments, battery backup device 100 includes additional or fewer accessory ports 120 and/or the system 300 includes additional or fewer accessories 115. In some embodiments, the accessories 115A-115D couple to each other and/or an accessory port 120A-120D via a plug, a cable, a USB connection, a dongle, etc. (e.g., in a daisy chain arrangement).

The accessories 115A-115D may include a battery charger, a battery pack (e.g., a removable and rechargeable power tool battery pack), a speaker, a fan, a light, an extension cord reel, a sensor (e.g., a carbon monoxide sensor, an environmental sensor, etc.), a park-assist laser, a smoke alarm, a folding light, a retractable area light, a security camera, an inflator cord reel, a smart device (e.g., a smart speaker), etc. In some embodiments, multiple of the same type of accessory is connected to the battery backup device 100. The operation of each of the variety of accessory devices and the manner in which each of the accessory devices may be coupled to an accessory port is described in greater detail in U.S. Pat. No. 9,978,265, issued on May 22, 2018, the entire content of which is hereby incorporated by reference.

The battery backup device 100 may additionally include an AC power cable 135 and AC power plug 140 for connecting to a source of AC power (e.g., AC mains power). The battery backup device 100 is configured to receive AC power by way of the AC power cable 135. The received AC power may be provided to the controller 125 and to a switch 130. The AC power provided to the controller 125 may be rectified by the controller 125 to produce DC power. DC power from the controller 125 may be available to be provided to the accessory ports 120A-120D for powering the accessories 115A-115D. For example, the controller 125 is configured to provide DC power to an accessory port 120A-120D when a battery pack is connected to the accessory port 120A-120D to charge the battery pack. In some embodiments, one or more of the accessories 115A-115D is a battery pack. In other embodiments, one or more of the accessories 115A-115D is a battery pack charger, and the battery pack charger is operable to receive one or more battery packs. In some embodiments, the battery backup device 100 does not receive a battery pack through one of the accessory ports 120A-120D. Rather, one end of the battery backup device 100 may be removable or openable and includes a receptacle specifically designed to receive a battery pack (e.g., a removable and rechargeable power tool battery pack). In such embodiments, the battery pack may not occupy one of the accessory ports 120A-120D and an additional accessory (e.g., a non-battery pack accessory) can be connected to the battery backup device 100.

The controller 125 is also configured to control the switch 130 to selectively provide power to an AC power outlet 145. The AC power outlet 145 may provide AC power to, for example, the garage door opener 200 via an AC power cable 205 and AC power plug 210 of the garage door opener 200. For example, AC power may passes through the battery backup device 100 to the garage door opener 200 during normal operating conditions, and the battery backup device 100 provides backup power to the garage door opener 200 during abnormal operating conditions (e.g., during a power outage). The controller 125 is configured to control the switch 130 to switch between a first mode of operation and a second mode of operation. In the first mode of operation, the battery backup device 100 is configured to pass AC power from the AC power cable 135 to the AC power outlet 145 via the switch 130. In the second mode of operation, the battery backup device 100 is configured to pass power stored in one or more of the accessories 115A-115D or a separate battery pack to the AC power outlet 145 via the switch 130. In some embodiments, changeover from the first mode of operation to the second mode of operation is achieved automatically using a relay when AC power to the battery backup device 100 is lost. In some embodiments, the controller 125 identifies or detects a power loss (e.g., using a sensor) and causes a battery pack and/or an accessory to discharge DC power for powering the garage door opener 200 when input AC power is lost.

When the battery backup device 100 passes power stored in one or more of the accessories 115A-115D or a separate battery pack to the AC power outlet 145, the controller 125 is configured to invert DC power to produce AC power. An accessory 115A-115D, or battery pack, that stores DC power is, for example, a power tool battery pack configured for powering power tools (e.g., drills/drivers, impact drills/drivers, hammer drills/drivers, saws, routers, etc.). In some embodiments, the accessory ports 120A-120D include a receiving portion for receiving such power tool battery packs. In other embodiments, the power tool battery pack is connected to the battery backup device 100 through a separate receptacle or another accessory, such as a battery pack charger. When connected through a battery charger, the battery pack charger includes a receiving portion for receiving the power tool battery pack, and the battery pack charger uses power received from the controller 125 to charge the battery pack. An exemplary battery pack and battery pack charger that may be connected to the battery backup device 100 are described in greater detail in U.S. Pat. No. 9,978,265, the entire content of which was previously incorporated by reference.

The battery backup device 100 is configured to pass power stored in one or more of the accessories 115A-115D or separate battery pack to the AC power outlet 145 when the battery backup device 100 detects a loss of AC power. As a result, when AC power is lost (i.e., no AC power is received via AC power cable 135) the battery backup device 100 is able to provide power to the garage door opener 200, and the garage door opener 200 remains operable to raise or lower a garage door, emit light, and/or the like. The garage door opener 200 may be operated based on signals received from, for example, a wall-mounted keypad, a passcode keypad, and/or a peripheral device (e.g., a smartphone-based application, etc.). The operation of an exemplary garage door opener is described in greater detail in U.S. Pat. No. 9,978,265, the entire content of which was previously incorporated by reference.

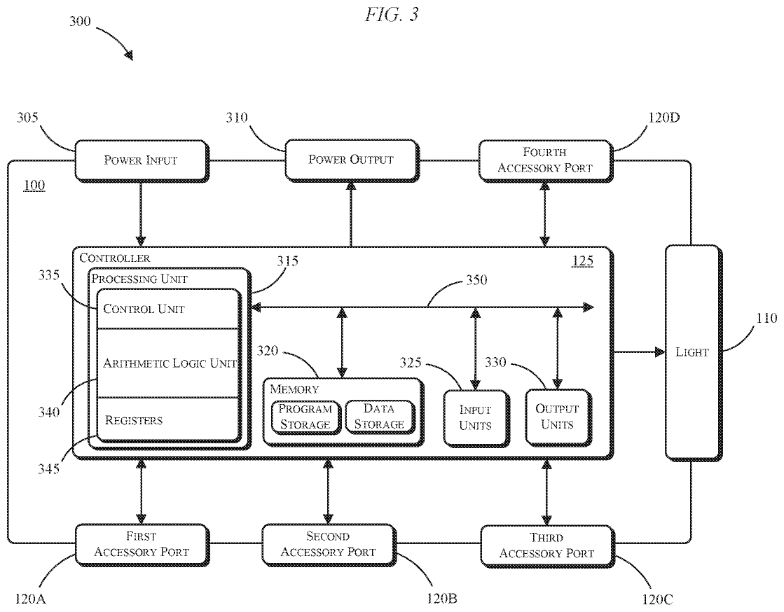

The operation of the battery backup device 100 and/or system 300 may be controlled, monitored, and/or regulated using the controller 125. FIG. 3 illustrates the controller 125 of the battery backup device 100 and system 300. The controller 125 is electrically and/or communicatively connected to a variety of modules or components of the battery backup device 100. For example, the illustrated controller 125 is connected to the light 110, the first accessory port 120A, the second accessory port 120B, the third accessory port 120C, the fourth accessory port 120D, a power input module 305, and a power output module 310. The controller 125 includes combinations of hardware and software that are operable to, among other things, control the operation of the battery backup device 100, control the power supplied to the accessory ports 120A-120D, control the switch 130, convert AC power to DC power, convert DC power to AC power, etc.

In some embodiments, the controller 125 includes a plurality of electrical and electronic components that provide power, operational control, and/or protection to the components and modules within the controller 125 and/or battery backup device 100. For example, the controller 125 includes, among other things, a processing unit 315 (e.g., a microprocessor, a microcontroller, or another suitable programmable device), a memory 320, input units 325, and output units 330. The processing unit 315 includes, among other things, a control unit 335, an arithmetic logic unit (“ALU”) 340, and a plurality of registers 345 (shown as a group of registers in FIG. 3), and is implemented using a known computer architecture (e.g., a modified Harvard architecture, a von Neumann architecture, etc.). The processing unit 315, the memory 320, the input units 325, and the output units 330, as well as the various modules connected to the controller 125 are connected by one or more control and/or data buses (e.g., common bus 350). The control and/or data buses are shown generally in FIG. 3 for illustrative purposes. The use of one or more control and/or data buses for the interconnection between and communication among the various modules and components would be known to a person skilled in the art in view of this disclosure.

The memory 320 is a non-transitory computer readable medium that includes, for example, a program storage area and a data storage area. The program storage area and the data storage area may include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 315 is connected to the memory 320 and executes software instructions that are capable of being stored in a RAM of the memory 320 (e.g., during execution), a ROM of the memory 320 (e.g., on a generally permanent basis), or another non-transitory computer readable medium such as another memory or a disc. Software included in the implementation of the battery backup device 100 may be stored in the memory 320 of the controller 125. The software includes, for example, firmware, one or more applications, program data, filters, rules, one or more program modules, and other executable instructions. The controller 125 is configured to retrieve from memory and execute, among other things, instructions related to the control of the battery backup device 100 described herein. In other embodiments, the controller 125 includes additional, fewer, or different components.

The power input module 305 includes, for example, the AC power cable 135, the AC power plug 140, and a rectifier circuit for converting input AC power to DC power. In some embodiments, the power input module 305 also includes one or more sensors (e.g., a voltage sensor, a current sensor, etc.) for detecting the presence or absence of AC power. The power input module 305 is illustrated as being separate from and connected to the controller 125. However, in some embodiments, components of the power input module 305 may also be included within the controller 125.

The power output module 310 includes, for example, the switch 130, the AC power outlet 145, and a voltage inverter circuit for converting DC power to AC power. Like the power input module 305, components of the power output module 310 may also be included within the controller 125. For example, for illustrative purposes, the switch 130 and the AC power outlet 145 are illustrated in FIG. 2 as being separate from the controller 125, and a voltage inverter circuit is described as being included within the circuitry of the controller 125.

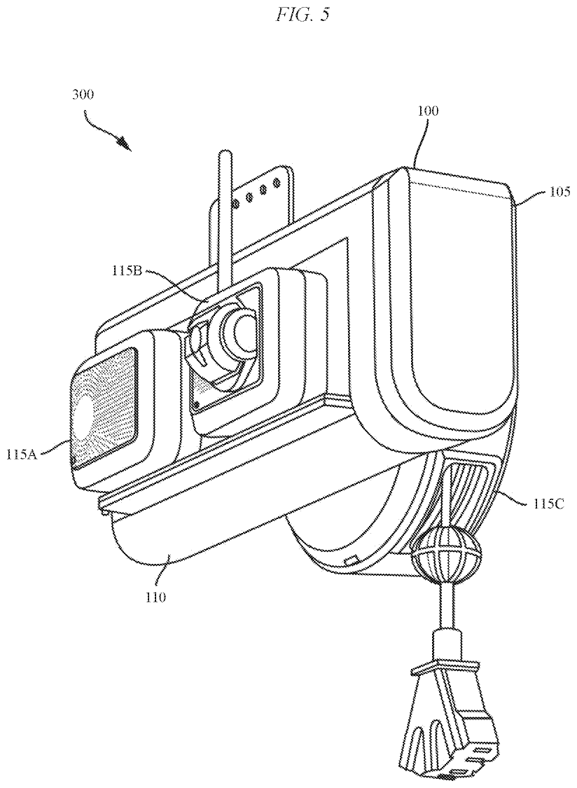

FIGS. 4 and 5 illustrate the battery backup device 100 including various accessories. For example, in the embodiments of the battery backup device 100 illustrated in FIGS. 4 and 5, the first accessory 115A is a speaker, the second accessory 115B is a security camera, and the third accessory 115C is a retractable cord reel.

Thus, embodiments described herein provide, among other things, a battery backup device for a garage door opener. Various features and advantages are set forth in the following claims.

What is claimed is:

1. A battery backup device for a garage door opener, the device comprising:
a housing;
an accessory port configured to receive a removable and rechargeable battery pack;
a power input module configured to receive alternating current (“AC”) power;
a power output module configured to output AC power to an AC power outlet; and
a controller configured to:
provide power to the accessory port,
receive power from the accessory port, and
control a switch between a first mode of operation and a second mode of operation, the first mode of operation including providing the received AC power to the power output module, the second mode of operation including providing power from the removable and rechargeable battery pack to the power output module,
wherein, when the power input module is receiving AC power, the switch is controlled to the first mode of operation, and
wherein, when the power input module is not receiving AC power, the switch is controlled to the second mode of operation.

2. The device of claim 1, further comprising a rectifier circuit configured to rectify the received AC power to produce rectified direct current (“DC”) power.

3. The device of claim 2, wherein the controller is configured to provide the rectified DC power to the removable and rechargeable battery pack to charge the removable and rechargeable battery pack.

4. The device of claim 3, further comprising a voltage inverter circuit configured to invert DC power from the removable and rechargeable battery pack to produce inverted AC power.

5. The device of claim 4, wherein the inverted AC power is provided to the power output module.

6. The device of claim 1, further comprising a second accessory port configured to receive an accessory,
wherein the controller is configured to provide power to the second accessory port.

7. The device of claim 6, wherein the accessory is a battery pack charger.

8. The device of claim 7, wherein the battery pack charger is configured to receive the removable and rechargeable battery pack.

9. The device of claim 8, wherein the battery pack charger is configured to use the power provided to the second accessory port by the controller to charge the removable and rechargeable battery pack.

10. The device of claim 6, wherein the accessory is selected from the group consisting of: a speaker, a fan, an extension cord reel, an environmental sensor, a park-assist laser, a folding light, a retractable area light, a security camera, and an inflator cord reel.

11. A battery backup system for a garage door opener, the system comprising:
a removable and rechargeable battery pack; and
a battery backup device including
a housing;
an accessory port configured to receive an accessory;
a power input module configured to receive alternating current (“AC”) power;
a power output module configured to output AC power to an AC power outlet; and
a controller configured to
provide power to the accessory port,
receive power from the removable and rechargeable battery pack, and
control a switch between a first mode of operation and a second mode of operation, the first mode of operation including providing the received AC power to the power output module, the second mode of operation including providing power from the removable and rechargeable battery pack to the power output module,
wherein, when the power input module is receiving AC power, the switch is controlled to the first mode of operation, and
wherein, when the power input module is not receiving AC power, the switch is controlled to the second mode of operation.

12. The system of claim 11, wherein the battery backup device further includes a rectifier circuit configured to rectify the received AC power to produce rectified direct current (“DC”) power.

13. The system of claim 12, wherein the controller is configured to provide the rectified DC power to the accessory port.

14. The system of claim 11, wherein the battery backup device further includes a voltage inverter circuit configured to invert DC power from the removable and rechargeable battery pack to produce inverted AC power.

15. The system of claim 14, wherein the inverted AC power is provided to the power output module.

16. The system of claim 11, wherein the accessory is selected from the group consisting of: a speaker, a fan, an extension cord reel, an environmental sensor, a park-assist laser, a folding light, a retractable area light, a security camera, and an inflator cord reel.

17. The system of claim 16, further comprising a second accessory port configured to receive a second accessory,
wherein the controller is configured to provide power to the second accessory port.

18. The system of claim 17, wherein the second accessory is a battery pack charger.

19. The system of claim 18, wherein the battery pack charger is configured to receive the removable and rechargeable battery pack.

20. The system of claim 19, wherein the battery pack charger is configured to use the power provided to the second accessory port by the controller to charge the removable and rechargeable battery pack.
